(19) United States
(12) Patent Application Publication
(10) Pub. No.: US 2013/0344580 A1
(43) Pub. Date: Dec. 26, 2013

(54) ASSISTANT DEVICE FOR PIPETTING

(71) Applicant: MAESTROGEN INC., Hsinchu City (TW)

(72) Inventors: SHUO-TING YAN, HSINCHU CITY (TW); JU-CHIN TSAI, HSINCHU CITY (TW); CHEN-CHUNG CHANG, HSINCHU CITY (TW); SY-HAW WANG, HSINCHU CITY (TW)

(73) Assignee: MAESTROGEN INC., Hsinchu City (TW)

(21) Appl. No.: 13/870,115

(22) Filed: Apr. 25, 2013

(30) Foreign Application Priority Data
Jun. 22, 2012 (TW) 101122497

(51) Int. Cl. G01N 1/10

(52) U.S. Cl. CPC G01N 1/10
USPC 435/288.7

(57) ABSTRACT

An assistant device for pipetting is disclosed. The assistant device for pipetting comprises: a multi-well plate, a first light emitting element array, a first photo detector array, a second light emitting element array, a second photo detector array, a control circuit, and a display. The multi-well plate comprises a plurality of wells for containing a solution, and the plurality of wells are disposed as an array. The first and second light emitting element arrays are disposed at adjacent sides of the multi-well plate. The first and second photo detector arrays are disposed at the side opposite to the first and second light emitting element arrays respectively. The control circuit is connected to the light emitting element arrays, the photo detector arrays, and the display to determine the amount of pipetting times of each of the wells and display on the display.

### FIELD OF THE INVENTION

The present invention is related to an assistant device for pipetting, more particularly an assistant device for pipetting which records and displays the amount of pipetting times of each well of a multi-well plate.

### BACKGROUND

The polymerase chain reaction (PCR) is a biochemical technology in molecular biology to amplify a single or a few copies of a piece of DNA across several orders of magnitude, generating thousands to millions of copies of a particular DNA sequence. In the PCR method, the two strands in a DNA double helix are physically separated at a high temperature DNA melting process. Each strand is used as the template in DNA synthesis by the DNA polymerase to selectively amplify the target DNA. When the temperature is lowered to an annealing temperature, the primers are annealed to the single-stranded DNA template. And then, the polymerase binds to the primer-template hybrid and begins DNA formation. After the new DNA strand complementary to the DNA template strand is polymerized, the DNA polymerase is separated from the DNA double helix, and the reaction is complete once.

In the PCR method, the new DNA double helix is used as the DNA template in the new cycle of the reaction. Such that, at each cycle of the reaction, the amount of DNA is doubled, leading to exponential amplification of the specific DNA fragment.

For the PCR method, a solution of the target DNA is pipetted into each well of a multi-well plate. And then, the multi-well plate with the solution is placed into the apparatus for PCR.

In usual, a multi-well plate comprises 96 wells, 384 wells, or at least 48 wells. It takes a lot of time to pipette the solution to all the wells of a multi-well plate. Once a pipetting process is interrupted, it is difficult for an experimenter to restart pipetting without missing or overlapping. Consequently, it would be helpful to provide an assistant device for pipetting.

### SUMMARY OF THE INVENTION

It is an objective of the present invention to provide an assistant device for pipetting, more particularly an assistant device for pipetting which records and displays the amount of pipetting times of each well of a multi-well plate.

It is another objective of the present invention to provide an assistant device for pipetting, which provides light emitting element arrays and photo detector arrays to detect the amount of pipetting times of each well of a multi-well plate, and displays on a display.

It is one objective of the present invention to provide an assistant device for pipetting, which displays the amount of pipetting times of each well by predetermined colors.

It is one objective of the present invention to provide an assistant device for pipetting, which displays the amount of pipetting times of each well by numbers.

The present invention provides an assistant device for pipetting, comprising: a multi-well plate having a plurality of wells, wherein the plurality of wells are disposed as an array with m rows and n columns, each of the wells is used for containing a solution; a first light emitting element array including a plurality of light emitting elements disposed at one side of the multi-well plate, wherein each of the light emitting elements of the first light emitting element array is associated with a column of the wells of the multi-well plate respectively, and generates a light beam passing above the associated column of wells; a first photo detector array including a plurality of photo detectors disposed at the side of the multi-well plate opposite to the first light emitting element array, wherein each of the photo detectors of the first photo detector array is associated with a light emitting element of the first light emitting element array respectively for detecting the light beam from the associated light emitting element; a second light emitting element array including a plurality of light emitting elements disposed at the side of the multi-well plate adjacent to the first light emitting element array, wherein each of the light emitting elements of the second light emitting element array is associated with a row of the wells of the multi-well plate respectively, and generates a light beam passing above the associated row of wells; a second photo detector array including a plurality of photo detectors disposed at the side of the multi-well opposite to the second light emitting element array, wherein each of the photo detectors of the second photo detector array is associated with a light emitting element of the second light emitting element array respectively for detecting the light beam from the associated light emitting element; a control circuit connected to the first light emitting element array, the first photo detector array, the second light emitting element array, and the second photo detector for detecting obstructed photo detectors and determining the amount of pipetting times of each of the wells; and a display connected to the control circuit and configured to display the amount of pipetting times of each well of the multi-well plate.

In one embodiment of the present invention, the assistant device for pipetting further comprises a holder for supporting the light emitting element arrays and the photo detector arrays.

In one embodiment of the present invention, the light emitting elements are LEDs.

In one embodiment of the present invention, the photo detectors are photodiodes.

In one embodiment of the present invention, the photo detector arrays are selectively embodied by charge-coupled devices (CCDs) or complementary metal-oxide-semiconductors (CMOSs).

In one embodiment of the present invention, the display is selectively one of a liquid crystal display (LCD), an LED display, or a tablet computer.

In one embodiment of the present invention, the display is configured to display spots at locations that corresponding to the wells of the multi-well plate and denote an amount of pipetting times of each well by a pre-determined color or pattern on the spot corresponding to the well.

In one embodiment of the present invention, the display is configured to display spots at locations that corresponding to the wells of the multi-well plate and denote an amount of pipetting times of each well by a number in the spot corresponding to the well.

In one embodiment of the present invention, a relationship between the light emitting elements of the first light emitting element array and columns of wells of the multi-well plate is selectively one by one corresponding or two or more to one corresponding.

In one embodiment of the present invention, a relationship between the light emitting elements of the second light emitting element array and rows of wells of the multi-well plate is selectively one by one corresponding or two or more to one corresponding.

The present invention further provides an assistant device for pipetting, comprising: a multi-well plate having a plurality of wells, wherein the plurality of wells are disposed as an array with m rows and n columns, each of the wells is used for containing a solution; a first light emitting element array including a plurality of light emitting elements disposed at one side of the multi-well plate, wherein each of the light emitting elements of the first light emitting element array is associated with a column of the wells of the multi-well plate respectively, and generates a light beam passing above the associated column of wells; a first photo detector array including a plurality of photo detectors disposed at the side of the multi-well plate opposite to the first light emitting element array, wherein each of the photo detectors of the first photo detector array is associated with a light emitting element of the first light emitting element array respectively for detecting the light beam from the associated light emitting element; a second light emitting element array including a plurality of light emitting elements disposed at the side of the multi-well plate adjacent to the first light emitting element array, wherein each of the light emitting elements of the second light emitting element array is associated with a row of the wells of the multi-well plate respectively, and generates a light beam passing above the associated row of wells; a second photo detector array including a plurality of photo detectors disposed at the side of the multi-well opposite to the second light emitting element array, wherein each of the photo detectors of the second photo detector array is associated with a light emitting element of the second light emitting element array respectively for detecting the light beam from the associated light emitting element; a control circuit connected to the first light emitting element array, the first photo detector array, the second light emitting element array, and the second photo detector for detecting obstructed photo detectors and determining the amount of pipetting times of each of the wells; and a display connected to the control circuit and configured to display the amount of pipetting times of each well of the multi-well plate; wherein a relationship between the light emitting elements of the first light emitting element array and columns of wells of the multi-well plate is selectively one by one corresponding or two or more to one corresponding; another relationship between the light emitting elements of the second light emitting element array and rows of wells of the multi-well plate is selectively one by one corresponding or two or more to one corresponding.

### BRIEF DESCRIPTION OF DRAWINGS

FIG. 1 is a schematic diagram of an assistant device for pipetting in accordance with one embodiment of the present invention.

FIG. 2 is a cross-sectional view of the embodiment shown in FIG. 1.

FIG. 3 is a schematic diagram of an assistant device for pipetting in accordance with another embodiment of the present invention.

FIG. 4 is a schematic diagram of an assistant device for pipetting in accordance with another embodiment of the present invention.

FIG. 5 is a schematic diagram of an assistant device for pipetting in accordance with another embodiment of the present invention.

### DETAILED DESCRIPTION

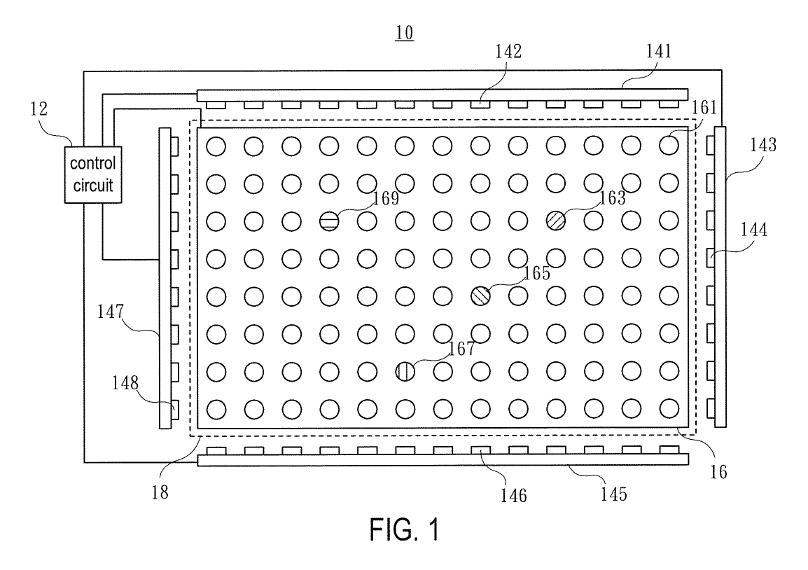

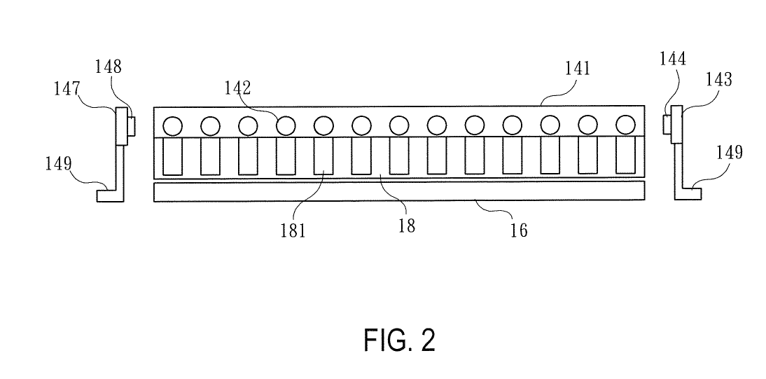

Referring to FIGS. 1 and 2, there are shown a schematic diagram and a cross-sectional view an assistant device for pipetting in accordance with one embodiment of the present invention. In the present embodiment, the assistant device for pipetting 10 comprises: a multi-well plate 18, a first light emitting element array 141, a first photo detector array 145, a second light emitting element array 143, a second photo detector array 147, a control circuit 12, and a display 16.

The multi-well plate 18 comprises a plurality of wells 181, and the plurality of wells are disposed as an array, for example an array with m rows and n columns. Each of the wells 181 is used for containing a solution. The first light emitting element array 143 comprises a plurality of light emitting elements 142, and is disposed at one side of the multi-well plate 18. Each of the light emitting elements 142 is associated with a column of the wells 181 of the multi-well plate 18 respectively. Each of the light emitting elements 142 generates a beam of light, and the light beam passes above the associated column of wells 181. The first photo detector array 145 comprises a plurality of photo detector 146, and is disposed at the side of the multi-well plate 18 opposite to the first light emitting element array 143. Each of the photo detectors 146 is associated with a light emitting element 142 of the first light emitting element array 141 respectively for detecting the light beam from the associated light emitting element 142.

The second light emitting element array 143 comprises a plurality of light emitting elements 144, and is disposed at the side of the multi-well plate 18 adjacent to the first light emitting element array 141. Each of the light emitting elements 144 is associated with a row of the wells 181 of the multi-well plate 18 respectively. Each of the light emitting elements 144 generates a beam of light, and the light beam passes above the associated row of wells 181. The second photo detector array 147 comprises a plurality of photo detector 148, and is disposed at the side of the multi-well plate 18 opposite to the second light emitting element array 143. Each of the photo detectors 148 is associated with a light emitting element 144 of the second light emitting element array 143 respectively for detecting the light beam from the associated light emitting element 144.

The control circuit 12 is connected to the light emitting element arrays 141 and 143, and the photo detector arrays 145 and 147. When pipetting, a pipette is moved to a well 181 to feed the well 181 with solution, and the light beams above the well 181 are obstructed. By detecting the obstructed photo detectors 146 and 148, the column and row of the well which is currently pipetted are determined by the control circuit 12. By counting the obstructed times of corresponding photo detectors 146 and 148, the amount of pipetting times of each well is determined by the control circuit 12.

The display 16 is connected to the control circuit 12, and is configured to display the amount of pipetting times of each well 181 of the multi-well plate 18.

In one embodiment of the present invention, the assistant device for pipetting 10 of the present invention further comprises a holder 149 for supporting the light emitting element arrays 141, 143 and the photo detector arrays 145, 147.

In one embodiment of the present invention, the display 16 is configured to display spots 161 at the locations that corresponding to the wells 181 of the multi-well plate 18, wherein the amount of pipetting times of each well 181 is denoted by a pre-determined color or pattern on the spot 161 corresponding to the well 181. For example, the different colors (patterns) on the spots 163, 165, 167, and 169 denote different amount of pipetting times.

In one embodiment of the present invention, the bottom of each well 181 of the multi-well plate 18 is transparent, and the display 16 is disposed under the multi-well plate 18. Consequently, users can observe the color (pattern) of the corresponding spot 161 displayed on the display 16 through the well 181 to determine the amount of pipetting times of the well 181.

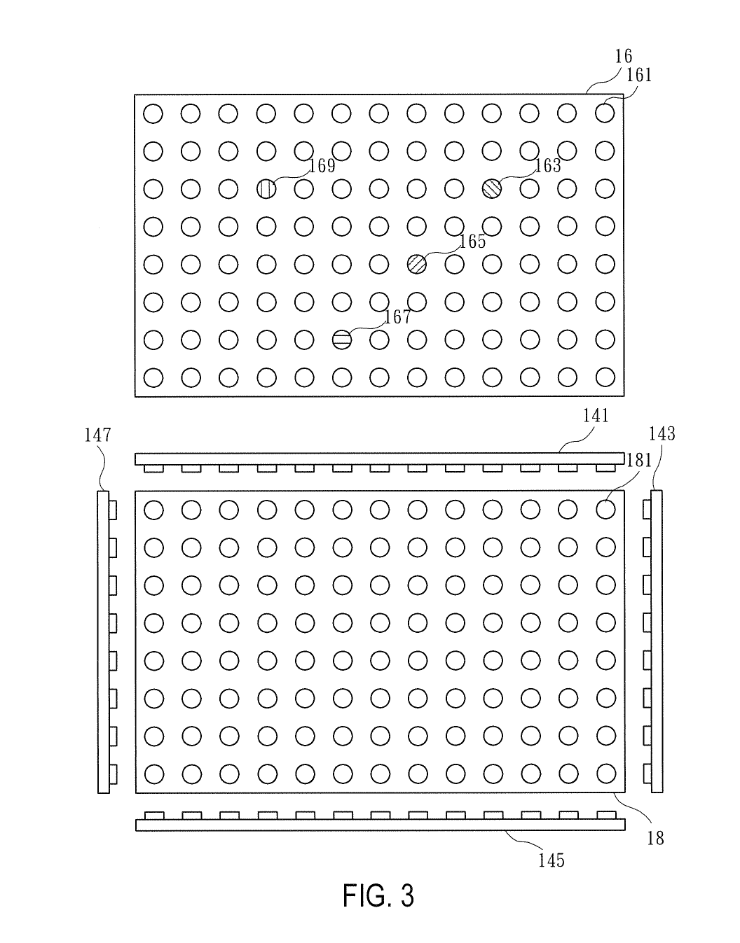

Referring to FIG. 3, there is shown a schematic diagram of an assistant device for pipetting in accordance with another embodiment of the present invention. In the present embodiment, the display 16 is disposed beside the multi-well plate 18. The display 16 configured to display spots 161 at the locations that corresponding to the wells 181 of the multi-well plate 18. The amount of pipetting times of each well 181 is denoted by a pre-determined color or pattern on the spot 161 corresponding to the well 181.

In the present embodiment, the bottom of the multi-well plate 18 can be transparent or opaque.

In the aforementioned embodiments, the relationship between the light emitting elements 142 of the first light emitting element array 141 and the columns of wells 181 of the multi-well plate 18 is one by one corresponding. The relationship between the light emitting elements 144 of the second light emitting element array 143 and the rows of wells 181 of the multi-well plate 18 is also one by one corresponding. In the present invention, the relationship can be different.

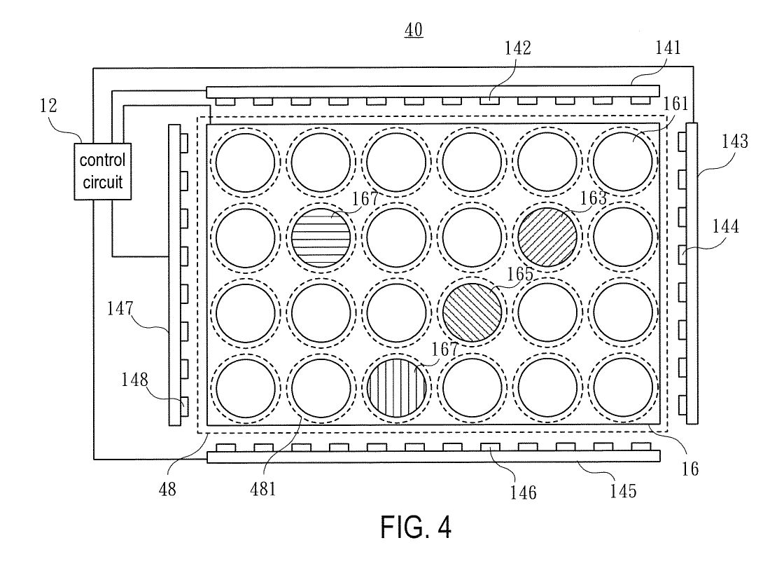

Referring to FIG. 4, there is shown a schematic diagram of an assistant device for pipetting 40 in accordance with another embodiment of the present invention. In the present embodiment, the multi-well plate 48 comprises a plurality of wells 481 with greater diameter.

Since the diameter of the well is greater, there is a greater region for the pipette to feed the well 481 with solution. To improve the sensitivity of the assistant device for pipetting 40, the relationship between the light emitting elements 142, 144 and the wells 481 is increased to two or more to one corresponding. In the present embodiment, the relationship between the light emitting elements 142 of the first light emitting element array 141 and the columns of wells 481 of the multi-well plate 48 is two to one corresponding. The relationship between the light emitting elements 144 of the second light emitting element array and the rows of wells 481 of the multi-well plate 48 is also two to one corresponding.

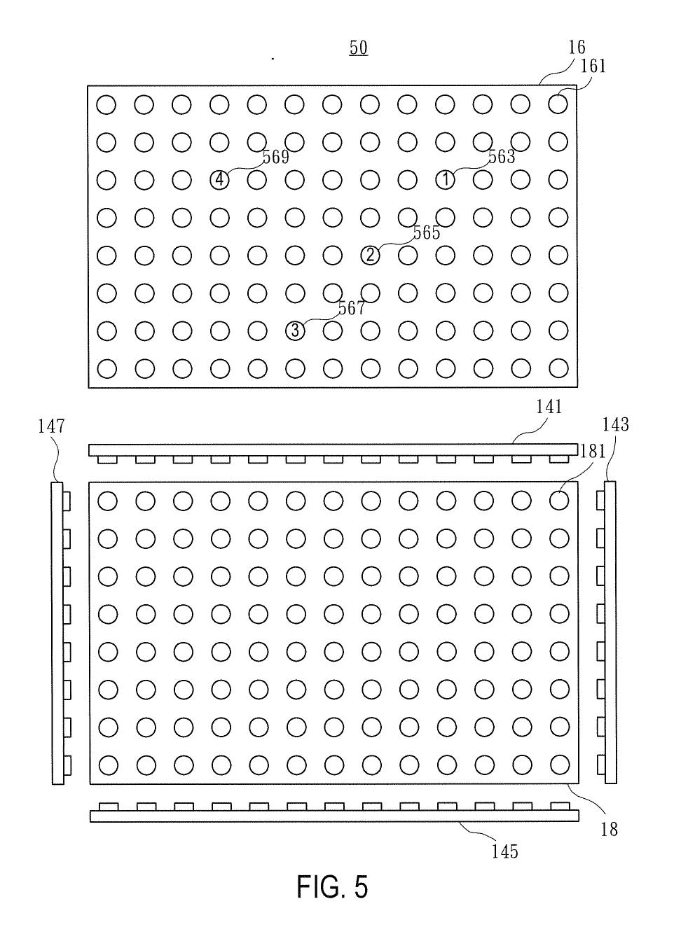

Referring to FIG. 5, there is shown a schematic diagram of an assistant device for pipetting 50 in accordance with another embodiment of the present invention. In the present embodiment, the amount of pipetting times of each well 181 is denoted in a different way.

In the present embodiment, the amount of pipetting times of each well 181 is denoted by a number in the spot 161. For example, the different numbers in the spots 563, 565, 567, and 569 denote the amount of pipetting times of corresponding wells 181.

In one embodiment of the present invention, the light emitting elements 142 and 144 are LEDs.

In one embodiment of the present invention, the photo detectors 146 and 148 are photodiodes.

In one embodiment of the present invention, the photo detector arrays 145 and 147 are selectively embodied by charge-coupled devices (CCDs) or complementary metal-oxide-semiconductors (CMOSs).

In one embodiment of the present invention, the display 16 is selectively one of a liquid crystal display (LCD), an LED display, or a tablet computer.

The assistant device for pipetting of the present invention can also be used for pipetting in method of enzyme-linked immunosorbent assay (ELISA).

The foregoing description is merely embodiments of the present invention and not considered as restrictive. All equivalent variations and modifications in shape, structure, feature, and spirit in accordance with the appended claims may be made without departing from the scope of the invention.

What is claimed is:

1. An assistant device for pipetting, comprising:
a multi-well plate having a plurality of wells, wherein the plurality of wells are disposed as an array with in rows and n columns, each of the wells is used for containing a solution;
a first light emitting element array including a plurality of light emitting elements disposed at one side of the multi-well plate, wherein each of the light emitting elements of the first light emitting element array is associated with a column of the wells of the multi-well plate respectively, and generates a light beam passing above the associated column of wells;
a first photo detector array including a plurality of photo detectors disposed at the side of the multi-well plate opposite to the first light emitting element array, wherein each of the photo detectors of the first photo detector array is associated with a light emitting element of the first light emitting element array respectively for detecting the light beam from the associated light emitting element;
a second light emitting element array including a plurality of light emitting elements disposed at the side of the multi-well plate adjacent to the first light emitting element array, wherein each of the light emitting elements of the second light emitting element array is associated with a row of the wells of the multi-well plate respectively, and generates a light beam passing above the associated row of wells;
a second photo detector array including a plurality of photo detectors disposed at the side of the multi-well opposite to the second light emitting element array, wherein each of the photo detectors of the second photo detector array is associated with a light emitting element of the second light emitting element array respectively for detecting the light beam from the associated light emitting element;
a control circuit connected to the first light emitting element array, the first photo detector array, the second light emitting element array, and the second photo detector for detecting obstructed photo detectors and determining the amount of pipetting times of each of the wells; and
a display connected to the control circuit and configured to display the amount of pipetting times of each well of the multi-well plate.

2. The assistant device for pipetting according to claim 1, further comprising a holder for supporting the light emitting element arrays and the photo detector arrays.

3. The assistant device for pipetting according to claim 1, wherein the light emitting elements are LEDs.

4. The assistant device for pipetting according to claim 1, wherein the photo detectors are photodiodes.

5. The assistant device for pipetting according to claim 1, wherein the photo detector arrays are selectively embodied by charge-coupled devices (CCDs) or complementary metal-oxide-semiconductors (CMOSs).

6. The assistant device for pipetting according to claim 1, wherein the display is selectively one of a liquid crystal display (LCD), an LED display, or a tablet computer.

7. The assistant device for pipetting according to claim 1, wherein the display is configured to display spots at locations that corresponding to the wells of the multi-well plate and denote an amount of pipetting times of each well by a pre-determined color or pattern on the spot corresponding to the well.

8. The assistant device for pipetting according to claim 1, wherein the display is configured to display spots at locations that corresponding to the wells of the multi-well plate and denote an amount of pipetting times of each well by a number in the spot corresponding to the well.

9. The assistant device for pipetting according to claim 1, wherein a relationship between the light emitting elements of the first light emitting element array and columns of wells of the multi-well plate is selectively one by one corresponding or two or more to one corresponding.

10. The assistant device for pipetting according to claim 1, wherein a relationship between the light emitting elements of the second light emitting element array and rows of wells of the multi-well plate is selectively one by one corresponding or two or more to one corresponding.

11. An assistant device for pipetting, comprising:
a multi-well plate having a plurality of wells, wherein the plurality of wells are disposed as an array with m rows and n columns, each of the wells is used for containing a solution;
a first light emitting element array including a plurality of light emitting elements disposed at one side of the multi-well plate, wherein each of the light emitting elements of the first light emitting element array is associated with a column of the wells of the multi-well plate respectively, and generates a light beam passing above the associated column of wells;
a first photo detector array including a plurality of photo detectors disposed at the side of the multi-well plate opposite to the first light emitting element array, wherein each of the photo detectors of the first photo detector array is associated with a light emitting element of the first light emitting element array respectively for detecting the light beam from the associated light emitting element;
a second light emitting element array including a plurality of light emitting elements disposed at the side of the multi-well plate adjacent to the first light emitting element array, wherein each of the light emitting elements of the second light emitting element array is associated with a row of the wells of the multi-well plate respectively, and generates a light beam passing above the associated row of wells;
a second photo detector array including a plurality of photo detectors disposed at the side of the multi-well opposite to the second light emitting element array, wherein each of the photo detectors of the second photo detector array is associated with a light emitting element of the second light emitting element array respectively for detecting the light beam from the associated light emitting element;
a control circuit connected to the first light emitting element array, the first photo detector array, the second light emitting element array, and the second photo detector for detecting obstructed photo detectors and determining the amount of pipetting times of each of the wells; and
a display connected to the control circuit and configured to display the amount of pipetting times of each well of the multi-well plate;
wherein a relationship between the light emitting elements of the first light emitting element array and columns of wells of the multi-well plate is selectively one by one corresponding or two or more to one corresponding; another relationship between the light emitting elements of the second light emitting element array and rows of wells of the multi-well plate is selectively one by one corresponding or two or more to one corresponding.
